(19) United States
(12) Patent Application Publication
(10) Pub. No.: US 2011/0217078 A1
(43) Pub. Date: Sep. 8, 2011

(54) ELECTROPHOTOGRAPHIC PHOTORECEPTOR AND IMAGE FORMING APPARATUS

(75) Inventors: Tomoko SAKIMURA, Tokyo (JP); Fumitaka MOCHIZUKI, Tokyo (JP); Shinichi YABUKI, Kanagawa (JP)

(73) Assignee: KONICA MINOLTA BUSINESS TECHNOLOGIES, INC., Tokyo (JP)

(21) Appl. No.: 13/037,616

(22) Filed: Mar. 1, 2011

(30) Foreign Application Priority Data
Mar. 8, 2010 (JP) 2010-050317

(51) Int. Cl. G03G 5/04; G03G 15/00

(52) U.S. Cl. 399/159; 430/69

(57) ABSTRACT

An organic photoreceptor having a photosensitive layer on a conductive support is disclosed, in which the photosensitive layer contains a pigment containing an adduct of titanyl phthalocyanine and at least either of (2R,3R)-2,3-butanediol and (2S,3S)-2,3-butanediol, the spectrum of the photosensitive layer has the absorption maximum value in the region of 750 to 780 nm, and the ratio of the absorbance at 780 nm (Abs 780) to the absorbance at 750 nm (Abs 750) (Abs 780/Abs 750, a value obtained by correcting the absorbance at 1000 nm as 0) is 0.6 to 1.0.

This application is based on Japanese Patent Application No. 2010-050317 filed on Mar. 8, 2010, in Japanese Patent Office, the entire content of which is hereby incorporated by reference.

### TECHNICAL FIELD

The present invention relates to an electrophotographic photoreceptor exhibiting high sensitivity and humidity independence and an image forming apparatus using the same.

### BACKGROUND

Over recent years, with the development of electronic devices, the frequency of use of copiers and printers utilizing electrophotography is more and more increasing. Electrophotographic photoreceptors (hereinafter, also referred to simply as photoreceptors) exhibiting high sensitivity are being disclosed one after another. Of these, Y-type titanyl phthalocyanine (hereinafter, also referred to simply as “Y-type pigment”) having the maximum peak at a Bragg angle 2θ of 27.2±0.2° in the powder X-ray diffraction spectrum is known as a high sensitive material and published in academic societies. Further, it was found out that such Y-type titanyl phthalocyanine exhibits decreased photon efficiency via dehydration treatment in a dry inert gas. When a Y-type pigment is allowed to be left stand under a normal temperature/humidity ambience and then water is allowed to be reabsorbed thereto, the Y-type pigment exhibits enhanced quantum efficiency again. From this fact, as one of the factors of exhibiting such enhanced photon efficiency, it is presumed that such a Y-type pigment has a crystalline structure containing water and then water molecules accelerate dissociation of holes and electrons of excitons having been generated by light.

With regard to an organic photoreceptor using such a material serving as a charge generating material, a problem has been noted in which sensitivity characteristics are varied depending on the environment, specifically humidity change. Over recent years, with the demand for high image quality, the disadvantage that the sensitivity of this Y-type pigment is largely humidity-dependent has become frequency problematic. For example, in cases in which it rained at night and then the weather cleared up on the following day, the sealed portion of an organic photoreceptor (the vicinity of a developing unit) maintains a high humidity ambience of the previous day and then a sensitivity difference from the remaining open portion of the photoreceptor is created, whereby immediate after the initiation of the first operation in the morning, in an image of intermediate density, a belt-shaped image defect produced by the sensitivity difference occurs.

To solve this humidity dependence, attempts to provide another polar group for a Y-type pigment instead of water have been made, and titanyl phthalocyanine pigments of 2,3-butanediol adducts are disclosed (Patent Document 1).

Further, of these, it is disclosed that titanyl phthalocyanine adducts of 2,3-butanediol having stereoregularity specifically exhibit excellent characteristics (Patent Documents 2 and 3). Of these, a mixed crystal of a titanyl phthalocyanine adduct of 2,3-butanediol and titanyl phthalocyanine is disclosed as a pigment exhibiting high sensitivity (Patent Document 4).

However, in any of these disclosed technologies, the humidity dependence of sensitivity was improved but in contrast, problems have been noted that sensitivity is still insufficient compared with the above Y-type pigments; during long-term use of a photoreceptor in a severe ambience such as high temperature/humidity, image density can be inadequately achieved due to potential change; and further image fogging occurs.

Therefore, for applications to an organic photoreceptor of a high speed digital copier in which high image quality, high-speed performance, and enhanced durability are required, it is necessary to improve humidity dependence and also to ensure realization of high sensitivity and repetitive potential stability.

### PRIOR ART DOCUMENTS

### Patent Documents

Patent Document 1: Unexamined Japanese Patent Application Publication (hereinafter referred to as JP-A) No. H05-273775
Patent Document 2: JP-A H07-173405
Patent Document 3: JP-A H08-82942
Patent Document 4: JP-A H09-230615

### BRIEF DISCLOSURE OF THE INVENTION

### Problems to be Solved by the Invention

The present invention was completed to solve the above problems.

Namely, an object of the present invention is to provide an electrophotographic photoreceptor in which a charge generating material exhibits high sensitivity which is at least the same as Y-type titanyl phthalocyanine; high repetitive potential stability is expressed; and sensitivity is humidity-independent, and an image forming apparatus using the photoreceptor.

### Means to Solve the Problems

The object of the present invention was found to be achieved by employing the following constitution:

(1) An organic photoreceptor having a photosensitive layer on a conductive support, wherein the photosensitive layer comprises a pigment containing an adduct of titanyl phthalocyanine and at least either of (2R,3R)-2,3-butanediol and (2S,3S)-2,3-butanediol; the spectrum of the photosensitive layer has the absorption maximum value in the region of 750 to 780 nm; and the ratio of the absorbance at 780 nm (Abs 780) to the absorbance at 750 nm (Abs 750) (Abs 780/Abs 750, a value obtained by correcting the absorbance at 1000 nm as 0) is 0.6 to 1.0.

(2) The electrophotographic photoreceptor described in (1), in which the pigment has a peak at least at a Bragg angle (2θ±0.2)° of 8.3° in the X-ray diffraction spectrum.

(3) The electrophotographic photoreceptor described in (1) or (2), in which the BET specific surface area of the pigment is at least 20 m²/g.

(4) An image fanning apparatus provided with at least a member to form an electrostatic latent image on the electrophotographic photoreceptor described in any of (1) to (3), a member to develop the electrostatic latent image using a toner, a member to transfer a formed toner image on an image support, and a member to fix a transferred toner image.

### Effects of the Invention

The present invention makes it possible to provide an electrophotographic photoreceptor in which a charge generating material exhibits high sensitivity which is at least the same as Y-type titanyl phthalocyanine; high repetitive potential stability is expressed; and sensitivity is humidity-independent, and an image fanning apparatus using the photoreceptor.

### BRIEF DESCRIPTION OF THE DRAWINGS

FIG. 1 is an example of the absorption spectrum of a photosensitive layer containing adduct of titanyl phthalocyanine of 2,3-butanediol.

FIG. 2-1 shows the X-ray diffraction spectrum of (9.5°-type) adduct of titanyl phthalocyanine of 2,3-butanediol having a characteristic peak at a Bragg angle 2θ (±0.2°) of 9.5°.

FIG. 2-2 shows the X-ray diffraction spectrum of (8.5° type) adduct of titanyl phthalocyanine of 2,3-butanediol having a characteristic peak at a Bragg angle 2θ (±0.2)° of 8.3°.

FIG. 3 is a sectional constitution view of a color image forming apparatus using an electrographic photoreceptor of the present invention.

FIG. 4 is a spectrum of Y-type titanyl phthalocyanine having a characteristic peak at a Bragg angle 2θ (±0.2°) of 27.2° in the X-ray diffraction spectrum.

### DESCRIPTION OF THE PREFERRED EMBODIMENT

The constitution of the present invention, materials used, and the constitution of an image forming apparatus used in the present invention will now be described.

In general, a photosensitive layer is formed in such a manner that a coating liquid, in which a charge generating material is dispersed in a solution prepared by dissolving a binder resin in an organic solvent, is coated and then dried. To enhance electrical and image characteristics in a photoreceptor, it is understood that it is critical to uniformly disperse a charge generating material in a photosensitive layer. In the case of insufficient dispersion, coarse particles are contained in a coating liquid, whereby a photosensitive layer having been formed using the coating liquid also contains coarse particles of a charge generating material, resulting in a decrease in electrical or image characteristics. Therefore, in the preparation step of a charge generating layer coating liquid, it is critical that such a charge generating material is sufficiently dispersed so that no secondarily aggregated particles or coarse particles are contained in the coating liquid.

On the other hand, when the dispersibility of a charge generating material is increased via high dispersion shearing, a uniformly dispersed coated film can be formed, but due to such dispersion shearing, the crystalline structure of the charge generating material is changed, whereby characteristics thereof are impaired, resulting in the possibility of sensitivity and potential stability problems.

The present inventors had a question in which a titanyl phthalocyanine pigment of a 2,3-butanediol adduct of the present invention exhibited high activity in a broken surface produced during pulverization, resulting in instability. Namely, it was presumed that in defect portions of a crystal generated in a broken surface produced during pulverization, desorption of butanediol or decomposition of a phthalocyanine ring tended to occur, whereby decomposed substances inhibited charge generation or became charge traps, resulting in adverse effects against sensitivity and repetitive characteristics.

Based on this presumption, in the present invention, an attempt to enhance dispersibility with no excessive stress applied to a pigment crystal was made. Thereby, it was found that pigment particles of small particle diameter were synthesized, and as a crystal during pigment synthesis was maintained, low shearing dispersion was carried out just for releasing secondary aggregation with no pulverization, whereby the problems were able to be solved. Further, investigations continued to be conducted and thereby it was found out that as a guideline, the ratio of Abs 780/Abs 750 could serve as an indicator showing the degree of compatibility of dispersibility and crystallinity maintenance.

From the investigation results of the present inventors, it was found out that when the spectrum of a photosensitive layer was determined, in the case where the absorption maximum value appeared at a region of 750 to 780 nm and also the ratio of the absorbance at 780 nm (Abs 780) to the absorbance at 750 nm (Abs 750) (Abs 780/Abs 750, a value obtained by correcting the absorbance at 1000 nm as 0) is 0.6 to 1.0, an electrophotographic photoreceptor exhibiting high sensitivity and enhanced repetitive potential stability was able to be obtained even with no humidity dependence of sensitivity. The Abs 780/Abs 750 value as defined above is preferably 0.65 to 0.95, and more preferably 0.7 to 0.9.

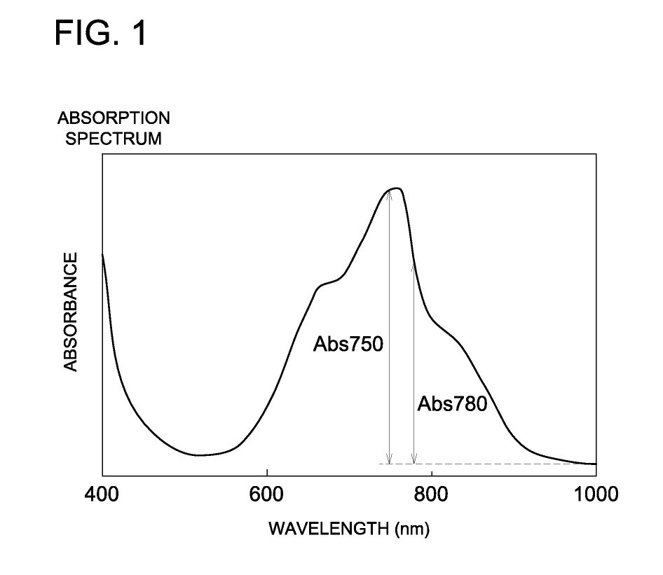

FIG. 1 is an example of the absorption spectrum of the photosensitive layer containing adduct of titanyl phthalocyanine of 2,3-butanediol according to the present invention.

In dispersion of the adduct of titanyl phthalocyanine of 2,3-butanediol, as dispersion of secondary aggregation and pulverization of a crystal progress, the absorption maximum is shifted to the short wavelength side and also the absorbance of a secondary absorption peak on the long wavelength side is relatively decreased, whereby Abs 780/Abs 750 is decreased.

In the case of an Abs 780/Abs 750 value of less than 0.6, it is shown that a pigment crystal has been pulverized by excessive dispersion shearing, whereby in defect portions of the crystal, adduct of titanyl phthalocyanine of 2,3-butanediol tends to be decomposed, resulting in the degradation of sensitivity and repetitive characteristics.

Further, in the case of an Abs 780/Abs 750 value of more than 1.0, it is shown that secondarily aggregated particles and coarse particles produced due to poor dispersion exist, whereby image defects such as fog tend to occur.

The spectrum of a photosensitive layer may be determined using a sample in which a photosensitive layer coating liquid where a charge generating material has been dispersed is coated on a transparent glass plate or a transparent PET base and dried, or may be determined by separating only a photosensitive layer from a photoreceptor.

The titanyl phthalocyanine pigment of a 2,3-butanediol adduct of the present invention is synthesized by chemical reaction to be described later.

The titanyl phthalocyanine pigment of a 2,3-butanediol adduct of the present invention has 2 types of crystal shapes based on the difference of the butanediol addition rate.

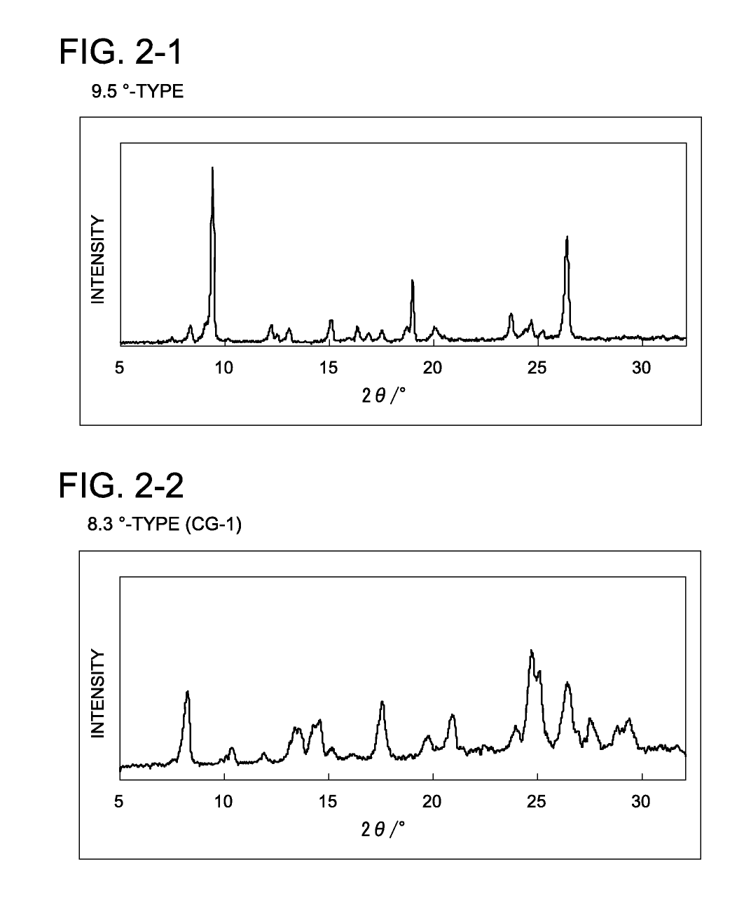

When titanyl phthalocyanine is allowed to react with at least either of (2R,3R)-2,3-butanediol and (2S,3S)-2,3-butanediol excessively, a pigment shown in FIG. 2-1 having a characteristic peak at a Bragg angle 2θ (±0.2) of 9.5° in the X-ray diffraction spectrum (hereinafter referred to as “9.5°-type”) is obtained. A titanyl phthalocyanine raw pigment of a butanediol adduct of the 9.5°-type has peaks at 16.4°, 19.1°, 24.7°, and 26.5° in addition to 9.5°.

From the facts that a Ti═O absorption in the vicinity of 970 cm⁻¹ disappeared in the IR spectrum and then an O—Ti—O absorption appeared in the vicinity of 630 cm⁻¹, and a mass decrease of about 11% occurred at 390 to 410° C. in thermal analysis (TG) (it is presumed that this phenomenon occurred due to the desorption of butylene oxide via thermal decomposition), as well as from the mass analysis result, titanyl phthalocyanine and (2R,3R)-2,3-butanediol or (2S,3S)-2,3-butanediol were condensed by dehydration at a ratio of 1/1.

On the other hand, when 1 mol of titanyl phthalocyanine is allowed to react with at most 1 mol of a butanediol compound, a pigment shown in FIG. 2-2 having a characteristic peak at a Bragg angle 2θ of 8.3° (±0.2)° in the powder X-ray diffraction spectrum (hereinafter referred to as “8.3°-type”) is obtained. A titanyl phthalocyanine pigment of a butanediol adduct of the 8.3°-type has peaks at 24.7°, 25.1°, and 26.5° in addition to 8.3°. In the pigment, both a Ti═O absorption in the vicinity of 970 cm⁻¹ and an O—Ti—O absorption in the vicinity of 630 cm⁻¹ appear in the IR spectrum thereof. Further, from the fact that a mass decrease of less than 11% occurs at 390 to 410° C. in thermal analysis and the mass analysis result, it is presumed that an adduct of butanediol/titanyl phthalocyanine=1/1 and titanyl phthalocyanine are formed into a mixed crystal at a certain ratio.

In general, a mixed crystal refers to a crystal in which the crystal is formed in a uniform miscible phase by mixing at least 2 types of materials. It is known that isomorphous salts as shown in alum and mixed crystals in the case of metals in which the crystal lattices are similar or the atomic radiuses are not too different are formed.

Also with regard to the phthalocyanine of the present invention, it is presumed that titanyl phthalocyanine and an adduct thereof with at least either of relatively similar (2R,3R)-2,3-butanediol and (2S,3S)-2,3-butanediol are mixed to form a uniform crystal, whereby a mixed crystal having a crystal shape as shown in FIG. 2-2 is formed.

The ratio of the butanediol adduct of the present invention in a mixed crystal is presumed to be 40 to 70 mol % based on the mass decrease at 390 to 410° C. in thermal analysis.

Herein, the above characteristic peak in the X-ray diffraction spectrum refers to a peak exhibiting an apparent difference exceeding the background variation.

In the present invention, from the viewpoint of realization of excellent sensitivity and repetitive potential stability, the pigment preferably has a characteristic peak at least at a Bragg angle (2θ±0.2°) of 8.3° in the X-ray diffraction spectrum.

Further, to achieve excellent dispersibility even in low shearing dispersion and then to produce a photoreceptor exhibiting excellent sensitivity and repetitive potential stability, it is desirable to produce and use a pigment particle of as small a particle diameter as possible. The BET specific surface area of the pigment is desirably at least 20 cm²/g, more preferably at least 30 cm²/g, and particularly preferably 30 to 100 cm²/g.

[Production Method of Titanyl Phthalocyanine Pigment of 2,3-Butanediol Adduct]

The pigment of the present invention containing an adduct of titanyl phthalocyanine and at least either of (2R,3R)-2,3-butanediol and (2S,3S)-2,3-butanediol can be synthesized in such a manner that titanyl phthalocyanine and (2R,3R)-2,3-butanediol or (2S,3S)-2,3-butanediol (hereinafter referred to as a butanediol compound) are allowed to react together in any appropriate solvent at room temperature or by heating. For titanyl phthalocyanine serving as a raw material, there can be employed any appropriate well-known synthesis method such as a synthesis method of obtaining from phthalonitrile and titanium tetrachloride, a synthesis method of obtaining from diiminoisoindoline and alkoxy titanium, or a synthesis method of obtaining from phthalonitrile, urea, and alkoxy titanium. A highly pure titanyl phthalocyanine of small chlorine content obtained from diiminoisoindoline and alkoxy titanium is specifically preferable. Further, titanyl phthalocyanine is preferably allowed to react with a butane diol compound after amorphous formation via a method such as acid paste treatment. In addition reaction of amorphous titanyl phthalocyanine and a butanediol compound, a fivefold to thirtyfold solvent is commonly used. The solvent is not specifically limited, and there can be listed various solvents including aromatic solvents such as chlorobenzene, dichlorobenzene, anisol, chloronaphthalene, or quinoline, ketone-based solvents such as methyl ethyl ketone, methyl isobutyl ketone, cyclohexanone, or acetophenone, ether-based solvents such as tetrahydrofuran, dioxolan, or diglyme, and further aprotic polar solvents such as dimethylformamide, dimethylacetamide, or dimethyl sulfoxide, as well as halogen-based solvents and ester-based solvents.

Reaction of titanyl phthalocyanine and a butanediol compound is described below. The reaction can be carried out under conditions of a wide temperature range. The reaction temperature is preferably in the range of 25 to 300° C. To synthesize a pigment of a BET specific surface area of at least 20 cm²/g, the temperature range is preferably in the range of 30 to 100° C.

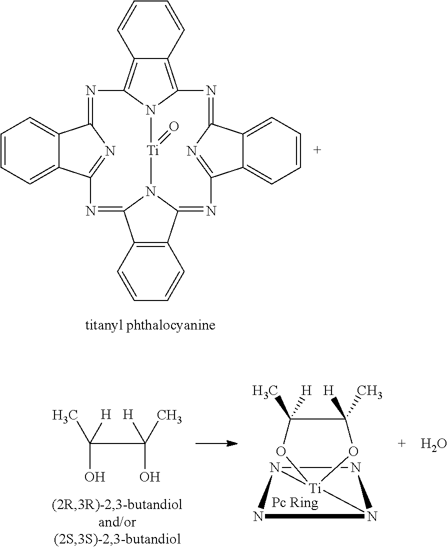

A butanediol compound is commonly added to titanyl phthalocyanine at a ratio of 0.2 to 2.0 mol based on 1 mol of the latter. For an adduct of the same mol, at least 1.0 mol of a diol compound needs to be used based on the above ratio. When the added amount of such a diol compound is at most 1.0 mol in the ratio, an adduct is obtained as a mixed crystal with titanyl phthalocyanine. Such a mixed crystal also falls within the scope of the present invention, provided that the dispersion absorption of the present invention is satisfied.

Further, a reaction product of titanyl phthalocyanine and a butanediol compound is preferably treated in a solvent in the presence of water. Via water treatment, a mixed-crystalline pigment containing adduct of titanyl phthalocyanine of 2,3-butanediol having a diol addition ratio realizing a thermally stable state can be stably obtained.

[Dispersion of Titanyl Phthalocyanine Pigment of 2,3-Butanediol Adduct]

To prepare a dispersion liquid of a charge generating layer using the titanyl phthalocyanine pigment of a butanediol adduct of the present invention, this pigment is dispersed in a solvent. The solvent is not specifically limited, and there can be listed various solvents including ketone-based solvents such as methyl ethyl ketone, methyl isopropyl ketone, methyl isobutyl ketone, cyclohexanone, or acetophenone; ether-based solvents such as tetrahydrofuran, dioxolan, or diglyme; alcohol-based solvents such as methyl cellosolve, ethyl cellosolve, or butanol; ester-based solvents such as ethyl acetate or t-butyl acetate; aromatic solvents such as toluene or chlorobenzene; and halogen-based solvents such as dichloroethane or trichloroethane.

A binder can be added in a dispersion liquid. Such a binder can be widely selected as long as the binder is dissolved in a used solvent, including a large number of compounds such as polyvinyl butyral, polyvinyl formal, polyvinyl acetate, polyvinyl chloride, polyamide, polycarbonate, and polyester, as well as copolymers thereof. The ratio of a binder to a pigment is not specifically limited, being, however, commonly 1/10 to 10/1. However, some disadvantages tend to be produced as follows: in the case of a small amount of a binder, a dispersion liquid becomes unstable and in the case of an excessive amount thereof, electrical resistance is increased and thereby the residual potential is increased via repetition in use as an electrophotographic photoreceptor.

The dispersion method used in the present invention is not limited, and media dispersion or medialess dispersion may be employed. However, low shearing dispersion (low shear dispersion) is preferable in which while a crystal during pigment synthesis is maintained, secondary aggregation is relaxed with no pulverization of primary particles.

Pulverization is not carried out such that primary particles are pulverized by applying direct mechanical shearing to pigment particles as in dry pulverization, and instead thereof, wet dispersion is preferably carried out with no excessive mechanical shearing.

As the medialess dispersion, ultrasonic dispersion is preferable in which no large mechanical shearing is applied and primary particles tend not to be fragmented. The ultrasonic dispersion method is not specifically limited, including a method in which an ultrasonic oscillator is directly immersed in a container containing a coating liquid, a method in which an ultrasonic oscillator is brought into contact with the outer wall of a container containing a coating liquid, and a method in which a solution containing a coating liquid is immersed in a liquid vibrated by an ultrasonic oscillator.

The media dispersion generally includes dispersion using a sand mill, a bead mill, a ball mill, or a paint conditioner. A used medium includes glass, zirconia, and ceramic beads. Of these, glass beads, which have small specific gravity, are preferable. The size of a bead is preferably at most 1 mm. When large beads are used, large impact energy is generated by the beads and thereby pigment particles are damaged.

In dispersion of the titanyl phthalocyanine pigment of a 2,3-butanediol adduct of the present invention, as the dispersion duration is extended, dispersion of secondary aggregation and crystal pulverization advance, whereby the absorbance of a sub-absorption peak on the long wavelength side is relatively decreased with short wavelength shifting of the absorption maximum, and then the ratio of Abs 780/Abs 750 becomes decreased. The optimum dispersion duration depends on the dispersion apparatus, the operation conditions of the dispersion apparatus, and the dispersion scale. However, when the spectrum of a coated layer of a dispersion liquid is determined, the moment when the absorption maximum value appears in a region of 750 to 780 nm and also the ratio of the absorbance at 780 nm (Abs 780) to the absorbance at 750 nm (Abs 750) (Abs 780/Abs 750, a value obtained by correcting the absorbance at 1000 nm as 0) is 0.6 to 1.0 can be designated as the guideline of dispersion termination.

[Production of Photoreceptor]

To produce an organic photoreceptor of the present invention, any appropriate well-known technology can be used as such. The constitution of such an organic photoreceptor used in the present invention will now be described.

In the present invention, the organic photoreceptor refers to an electrophotographic photoreceptor constituted in such a manner that an organic compound is allowed to have at least either of a charge generating function and a charge transporting function essential for the constitution of an electrophotographic photoreceptor, and the organic photoreceptor includes all the conventionally well-known organic electrophotographic photoreceptors such as photoreceptors containing a well-known organic charge generating material or organic charge transporting material and photoreceptors in which the charge generating function and the charge transporting function are provided using a polymer complex.

The layer constitution of the organic photoreceptor is not specifically limited, basically containing photosensitive layers such as a charge generating layer and a charge transporting layer, or a charge generating/charge transporting layer (a layer having a charge generating and a charge transporting function in the single layer), but a constitution may be made by coating, thereon, a surface layer. Further, the surface layer preferably has a protective layer function and a charge transporting function.

The constitution of a specific photoreceptor used in the present invention will now be described.

(Conductive Support)

As a conductive support used in the photoreceptor of the present invention, a sheet or cylindrical conductive support is used.

The cylindrical conductive support of the present invention refers to a cylindrical support required to form an image endlessly via rotation. A conductive support falling within a straightness of at most 0.1 mm and a deflection of at most 0.1 mm is preferable. In the case of exceeding the range of the straightness and deflection, excellent image formation is hard to carry out.

As a material for the conductive support, there can be used a metal drum such as aluminum or nickel, a plastic drum deposited with aluminum, tin oxide, or indium oxide, or a paper or plastic drum coated with a conductive material. The conductive support preferably features a specific resistance of at most 10³ Ω·cm at normal temperature.

As the conductive support used in the present invention, a support on which a sealing-treated alumite film has been formed may be used. Alumite treatment is commonly carried out in an acid bath such as chromic acid, sulfuric acid, oxalic acid, phosphoric acid, boric acid, or sulfamic acid. Of these, anodization treatment in sulfuric acid produces the most preferable result. Such anodization treatment in sulfuric acid is preferably carried out at a sulfuric acid concentration of 100 to 200 g/l, an aluminum ion concentration of 1 to 10 g/l, a liquid temperature of about 20° C., and an applied voltage of about 20 V. However, these conditions are not limited. Further, the average film thickness of an anodized coated film is commonly at most 20 μm, specifically preferably at most 10 μm.

(Intermediate Layer)

In the present invention, an intermediate layer provided with a barrier function is preferably arranged between a conductive support and a photosensitive layer. An intermediate layer in which titanium oxide fine particles are dispersed and incorporated in a binder resin such as polyamide is specifically preferable. The average particle diameter of such titanium oxide particles is commonly in the range of 10 nm to 400 nm, preferably 15 nm to 200 nm, in terms of number average primary particle diameter. In the case of less than 10 nm, the intermediate layer produces a poor preventing effect for moire occurrence. In contrast, in the case of more than 400 nm, titanium oxide particles in an intermediate layer coating liquid tend to be precipitated, whereby the uniform dispersibility of the titanium oxide particles in the intermediate layer tends to be degraded and also black spots are liable to be increased. An intermediate layer coating liquid, employing titanium oxide particles featuring a number average primary particle diameter of the above range, exhibits excellent dispersion stability, and further, an intermediate layer having been formed using such a coating liquid has a black spot preventing function and also exhibits excellent environmental characteristics and cracking resistance.

The shape of titanium oxide particles used in the present invention includes shapes such as dendritic, needle, and granular ones. With regard to titanium oxide particles of such a shape, for example, in titanium oxide particles, there are an anatase type, a rutile type, and an amorphous type in the crystal type. Those having any of these crystal types may be used, and at least 2 kinds of the crystal types may be used in combination. Of these, those, which are of a rutile type and granular, are most preferable.

The titanium oxide particles of the present invention are preferably surface-treated. Of these, preferable are those which are surface-treated more than once and also surface-treated using a reactive organic silicon compound as the final surface treatment in the surface treatments of multiple times. Further, of the surface treatments of multiple times, it is preferable that at least one surface treatment is carried out using at least one kind selected from alumina, silica, and zirconia, and then a surface treatment using a reactive organic silicon compound is carried out for the last time.

Herein, alumina treatment, silica treatment, or zirconia treatment refers to treatment to allow alumina, silica, or zirconia to be deposited on the surface of titanium oxide particles, respectively. Such alumina, silica, or zirconia deposited on the surface includes a hydrate of alumina, silica, or zirconia. Further, the surface treatment with a reactive organic silicon compound refers to the use of a reactive organic silicon compound for a treatment liquid.

In such a manner, titanium oxide particles are surface-treated at least twice, whereby the surface of the titanium oxide particles is uniformly subjected to surface coating (treatment). When the thus-surface-treated titanium oxide particles are used in an intermediate layer, there can be obtained an excellent photoreceptor exhibiting enhanced titanium oxide particle dispersibility in an intermediate layer and producing no image defects such as black spots.

A reactive organic silicon compound used for such surface treatment includes various kinds of alkoxy silanes such as methyl trimethoxy silane, n-butyl trimethoxy silane, n-hexyl trimethoxy silane, or dimethyl dimethoxy silane, as well as methylhydrogen polysiloxane.

(Photosensitive Layer)

The photosensitive layer constitution of the photoreceptor of the present invention may be a photosensitive layer constitution of a monolayer structure allowing a single layer to have a charge generating function and a charge transportation function on the above intermediate layer, being, however, preferably a constitution in which the function of the photosensitive layer is separately assigned to a charge generating layer (CGL) and a charge transporting layer (CTL). With such a constitution having the thus-divided functions, the residual potential increase due to repetitive use can be controlled to be smaller, and other electrophotographic characteristics are easily controlled for the intended purposes. In a negatively charged photoreceptor, preferable is such a constitution that a charge generating layer (CGL) is provided on an intermediate layer and thereon, a charge transporting layer (CTL) is provided. In a positively charged photoreceptor, the order of the above layer constitution is reversed with respect to the negatively charged photoreceptor. The most preferable photosensitive layer constitution of the present invention is a negatively charged photoreceptor constitution having the above function-divided constitution.

The photosensitive layer constitution of such a function-divided negatively charged photoreceptor will now be described.

(Charge Generating Layer)

A charge generating layer contains a charge generating material (CGM). As other materials, a binder resin and other additives may be contained therein as appropriate.

In the organic photoreceptor of the present invention, as a charge generating material, a titanyl phthalocyanine pigment of a butanediol adduct described above is used. However, another pigment such as phthalocyanine pigment, azo pigment, perylene pigment, or azulenium pigment is usable in combination.

When a binder is used as a dispersion medium of a CGM in a charge generating layer, as the binder, a well-known resin can be used. However, a resin most preferably used includes a formal resin, a butyral rein, a silicone resin, a silicone-modified butyral resin, and a phenoxy resin. With regard to the ratio of a binder resin and a charge generating material, the charge generating material is preferably in the range of 20 to 600 parts by mass based on 100 parts by mass of the binder resin. When these resins are used, the residual potential increase via repetitive use can be minimized. The film thickness of the charge generating layer is preferably 0.1 μm to 2 μm.

(Charge Transporting Layer)

A charge transporting layer contains a charge transporting material (CTM) and a binder resin which disperses the CTM for film formation. As other materials, additives such as an antioxidant may be contained as appropriate.

As the charge transporting material (CTM), a well-known charge transporting material (CTM) is usable. For example, a triphenylamine derivative, a hydrazone compound, a stryl compound, a benzidine compound, or a butadiene compound can be used. Any of these charge transporting materials is commonly dissolved in an appropriate binder resin for layer formation.

As the binder resin used for a charge transporting layer (CTL), any of thermoplastic resins or thermally curable resins is usable. There are listed, for example, polystyrene, an acrylic resin, a methacrylic resin, a vinyl chloride resin, a vinyl acetate resin, a polyvinyl butyral resin, an epoxy resin, a polyurethane resin, a phenol rein, a polyester resin, an alkyd resin, a polycarbonate resin, a silicone resin, a melamine resin, and a copolymer resin having at least 2 repeating unit structures of these resins. In addition to these insulating resins, polymer organic semiconductors such as poly-N-vinyl carbazole are also exemplified. Of these, a polycarbonate resin is most preferable in view of less moisture absorption rate, as well as excellent CTM dispersibility and electrophotographic characteristics.

With regard to the ratio of a binder resin and a charge transporting material, the charge transporting material is preferably in the range of 10 to 200 parts by mass based on 100 parts by mass of the binder resin. Further, the film thickness of the charge transporting layer is preferably 10 to 40 μm.

As described above, the most preferable layer constitution of the photoreceptor of the present invention has been exemplified. However, in the present invention, photoreceptor layer constitutions other the above one may be employed.

Solvents or dispersion media used for layer formation of a photosensitive layer include n-butylamine, diethylamine, ethylenediamine, isopropanolamine, triethanolamine, triethylenediamine, N,N-dimethylformamide, acetone, methyl ethyl ketone, methyl isopropyl ketone, cyclohexanone, benzene, toluene, xylene, chloroform, dichloromethane, 1,2-dichloroethane, 1,2-dichloropropane, 1,1,2-trichloroethane, 1,1,1-trichloroethane, trichloroethylene, tetrachloroethane, tetrahydrofuran, dioxolan, dioxane, methanol, ethanol, butanol, isopropanol, ethyl acetate, butyl acetate, dimethylsulfoxide, and methyl cellosolve. The present invention is not limited thereby. However, toluene, tetrahydrofuran, and dioxolan are preferably used. Further, these solvents can be used individually or as a mixed solvent of at least 2 kinds thereof.

Next, as the coating processing method to produce an organic photoreceptor, a coating processing method employing, for example, immersion coating, spray coating, or circular amount regulation type coating is used. However, in coating processing on the upper layer side of a photosensitive layer, in order for a film of the lower layer to be dissolved as little as possible and also to realize uniform coating processing, it is preferable to use a coating process method such as spray coating or circular amount regulation type (a typical example thereof is a circular slide hopper type) coating. Herein, for a protective layer, the above circular amount regulation type coating processing method is most preferably used. The circular amount regulation type coating is detailed, for example, in JP-A S58-189061.

[Image Forming Apparatus]

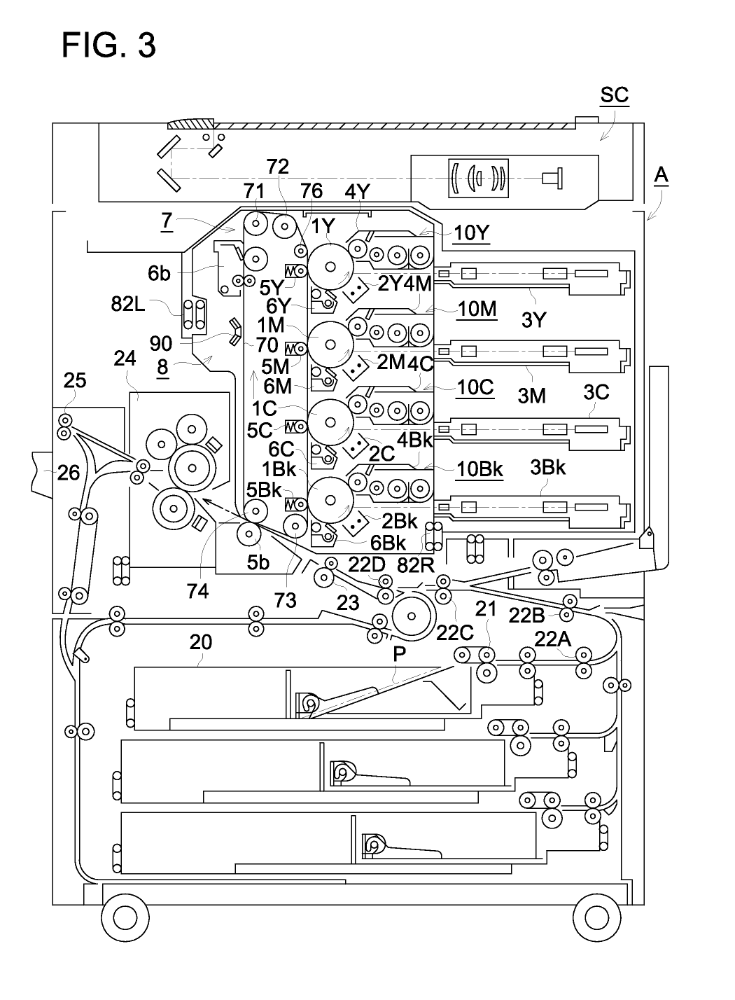

FIG. 3 is a sectional constitution view of a color image forming apparatus showing one embodiment of the present invention.

In the image forming apparatus of the present invention, when an electrostatic latent image is formed on a photoreceptor, a semiconductor laser or a light emitting diode of an oscillation wavelength of 350 to 850 nm is desirably used as an image exposure light source. Using such an image exposure light source, the exposure dot diameter in the primary scanning direction of writing is focused to 10 to 100 μm, whereby digital exposure is carried out on an organic photoreceptor to obtain an electrophotographic image of a high resolution of 600 dpi (dpi: the number of dots per 2.54 cm) to 2400 dpi or more.

The above exposure dot diameter refers to an exposure beam length (Ld: determined at the maximum location of the length) in the primary scanning direction of an area in which the intensity of the exposure beam is at least 1/e² of the peak intensity.

For light beams used, usable are a scanning optical system employing a semiconductor laser and an LED solid scanner. Light intensity distribution includes Gaussian distribution and Lorentz distribution, and each area of at least 1/e² of the peak intensity is designated as the exposure dot diameter of the present invention.

This color image forming apparatus is referred to as a tandem-type color image forming apparatus, incorporating 4 sets of image forming sections (image forming units) 10Y, 10M, 10C, and 10Bk, an endless belt-shaped intermediate transfer unit 7, a sheet feed conveyance member 21, and a fixing member 24. On top of the image forming apparatus main body A, the document image reading apparatus SC is arranged.

The image forming section 10Y, forming a yellow image, has a charging member (charging step) 2Y, an exposure member (exposure step) 3Y, a developing member (developing step) 4Y, a primary transfer roller 5Y as a primary transfer member (primary transfer step), and a cleaning member 6Y arranged in the periphery of a drum-shaped photoreceptor 1Y as a first image carrier. The image forming section 10M, forming a magenta image, has a drum-shaped photoreceptor 1M as a first image carrier, a charging member 2M, an exposure member 3M, a developing member 4M, a primary transfer roller 5M as a primary transfer member, and a cleaning member 6M. The image forming section 10C, forming a cyan image, has a drum-shaped photoreceptor 1C as a first image carrier, a charging member 2C, an exposure member 3C, a developing member 4C, a primary transfer roller 5C as a primary transfer member, and a cleaning member 6C. The image forming section 10Bk, forming a black image, has a drum-shaped photoreceptor 1Bk as a first image carrier, a charging member 2Bk, an exposure member 3Bk, a developing member 4Bk, a primary transfer roller 5Bk as a primary transfer member, and a cleaning member 6Bk.

Four sets of the image forming units 10Y, 10M, 10C, and 10Bk incorporate, around the centrally located photoreceptor drums 1Y, 1M, 1C, and 1Bk, the charging members 2Y, 2M, 2C, and 2Bk; the image exposure members 3Y, 3M, 3C, and 3Bk; the developing members 4Y, 4M, 4C, and 4Bk; and the cleaning members 6Y, 6M, 6C, and 6Bk to clean the photoreceptor drums 1Y, 1M, 1C, and 1Bk, respectively.

The image forming units 10Y, 10M, 10C, and 10Bk each have the same constitution in which only the color of each toner image formed on the photoreceptors 1Y, 1M, 1C, and 1Bk differs. Therefore, the image forming unit 10Y will now be detailed as an example.

In the image forming unit 10Y, in the periphery of the photoreceptor drum 1Y serving as an image forming body, there are arranged the charging member 2Y (hereinafter referred to simply as the charging member 2Y or the charging unit 2Y), the exposure member 3Y, the developing member 4Y, and the cleaning member 5Y (hereinafter referred to simply as the cleaning member 5Y or the cleaning blade 5Y) to form a toner image of yellow (Y) on the photoreceptor drum 1Y. Further, in the present embodiment, in such an image forming unit 10Y, at least the photoreceptor drum 1Y, the charging member 2Y, the developing member 4Y, and the cleaning member 5Y are arranged into a single unit.

The charging member 2Y is a member to uniformly apply a potential to the photoreceptor drum 1Y. In the present embodiment, a corona discharge-type charging unit 2Y is used for the photoreceptor drum 1Y.

The image exposure member 3Y is a member to carry out exposure onto the photoreceptor drum 1Y, having been provided with a uniform potential by the charging unit 2Y, based on an image signal (yellow) to form an electrostatic latent image corresponding to a yellow image. For this exposure member 3Y, there are used those incorporating an LED in which light-emitting elements are array-arranged in the axial direction of the photoreceptor drum 1Y and an imaging element, or laser optical systems.

The image forming apparatus of the present invention may be constituted in such a manner that the above photoreceptor and constituent elements such as a developing unit and a cleaning unit are combined into a unit as a process cartridge (an image forming unit), and then this image forming unit may be constituted so as to be fully detachable to the apparatus main body. Further, it is possible to employ the following constitution: a process cartridge (an image forming unit) is formed so as to hold at least one of a charging unit, an image exposure unit, a developing unit, a transfer or separation unit, and a cleaning unit together with a photoreceptor as a unit to form a single image forming unit fully detachable to the apparatus main body in which the single unit is allowed to be fully detachable using a guide member such as rails of the apparatus main body.

The endless belt-shaped intermediate transfer body unit 7, which is wound around a plurality of rollers, has an endless belt-shaped intermediate transfer body 70 as a semiconductive endless belt-shaped second image carrier which is rotatably supported.

Each of the color images formed by the image forming units 10Y, 10M, 10C, and 10Bk is successively transferred onto the rotating endless belt-shaped intermediate transfer body 70 by the primary transfer rollers 5Y, 5M, 5C, and 5Bk as primary transfer members to form a composed color image. An image support P as an image support (a support carrying a finally fixed image, for example, plain paper or a transparent sheet) accommodated in a sheet feeding cassette 20 is fed by a sheet feeding member 21, and passed through a plurality of intermediate rollers 22A, 22B, 22C, and 22D, and a registration roller 23, followed by being conveyed to a secondary transfer roller 5b, serving as a secondary transfer member, whereby secondary transfer is carried out onto the image support P for collective color image transfer. The image support P, on which the color images have been transferred, is subjected to fixing treatment using the fixing member 24, and then is nipped by a sheet discharging roller 25 and placed onto a sheet discharging tray 26 outside the apparatus. Herein, transfer supports for a toner image having been formed on a photoreceptor such as an intermediate transfer body or an image support are collectively referred to as transfer media.

On the other hand, the color image is transferred onto the image support P by the secondary transfer roller 5b as a secondary transfer member, and thereafter the residual toner on the endless belt-shaped intermediate transfer body 70, which has curvature-separated the image support P, is removed by the cleaning member 6b.

During image forming processing, the primary transfer roller 5Bk is always in pressure contact with the photoreceptor 1Bk. The other primary transfer rollers 5Y, 5M, and 5C each are brought into pressure contact with the corresponding photoreceptors 1Y, 1M, and 1C only during color image formation.

The secondary transfer roller 5b is brought into pressure contact with the endless belt-shaped intermediate transfer body 70 only when an image support P is passed at this roller position for the secondary transfer.

Further, the housing 8 is constituted so as to be withdrawn from the apparatus main body A via supporting rails 82L and 82R.

The housing 8 incorporates the image forming sections 10Y, 10M, 10C, and 10Bk, and the endless belt-shaped intermediate transfer body unit 7.

The image forming sections 10Y, 10M, 10C, and 10Bk are tandemly arranged in the perpendicular direction. The endless belt-shaped intermediate transfer body unit 7 is arranged on the left side of the photoreceptors 1Y, 1M, 1C, and 1Bk as shown in the drawing. The endless belt-shaped intermediate transfer body unit 7 incorporates the rotatable endless belt-shaped intermediate transfer body 70 wound around the rollers 71, 72, 73, and 74, the primary transfer rollers 5Y, 5M, 5C, and 5Bk, and the cleaning member 6b.

The image forming apparatus of the present invention is applied to general electrophotographic apparatuses such as electrophotographic copiers, laser printers, LED printers, and liquid crystal shutter printers, being further widely applicable to apparatuses for display, recording, quick printing, plate making, and facsimile employing electrophotographic technology.

### EXAMPLES

The constitution and effects of the present invention will now be described with reference to an embodiment. However, it goes without saying that the embodiment of the present invention is limited thereto. Herein, “parts” in the following description refers to “parts by mass.”

### Synthesis Example 1

### Synthesis of Amorphous Titanyl Phthalocyanine

There was dispersed 29.2 g of 1,3-diiminoisoindoline in 200 ml of ortho-dichlorobenzene and then 20.4 g of tetra-n-butoxytitanium was added, followed by heating for 5 hours at 150 to 160° C. under nitrogen ambience. After cooling in air, a precipitated crystal was filtered and washed with chloroform and then with a 2% hydrochloric acid aqueous solution, followed by water washing, methanol washing, and drying to give 26.2 g (yield: 91%) of raw titanyl phthalocyanine. Subsequently, the raw titanyl phthalocyanine was dissolved in 250 ml of concentrated sulfuric acid by stirring at 5° C. or less for 1 hour to be poured into 5 L of water of 20° C. A precipitated crystal was filtered and sufficiently washed with water to give 225 g of a wet paste product. Then, the wet paste product was frozen in a freezer and then unfrozen again, followed by filtration and drying to give 24.8 g (yield: 86%) of amorphous titanyl phthalocyanine.

### Synthesis of Titanyl Phthalocyanine of (2R,3R)-2,3-Butanediol Adduct CG-1

In 200 ml of ortho-chlorobenzene (ODB), 10.0 g of the above amorphous titanyl phthalocyanine and 1.30 g (0.83 equivalent ratio) of (2R,3R)-2,3-butanediol (the equivalent ratio is one with respect to the titanyl phthalocyanine, which is the same in the following description) were mixed and then stirred by heating at 60 to 70° C. for 6.0 hours. After being left stand overnight, the reaction liquid was added with 100 ml of water, followed by stirring by heating at 60 to 70° C. for 6.0 hours for hydrolysis reaction (hydrolysis step). After the hydrolysis reaction, the reaction liquid was cooled in air and then a crystal having been generated by adding methanol was filtered, followed by washing of the filtered crystal with methanol to give 10.3 g of CG-1 (a pigment containing titanyl phthalocyanine of a (2R,3R)-2,3-dutanediol adduct). The X-ray diffraction spectrum of CG-1 is shown in FIG. 2-2. Clear peaks appear at 8.3°, 24.7°, 25.1°, and 26.5°. In the mass spectrum, peaks appear at 576 and 648. In the IR spectrum, both absorptions of Ti═O and O—Ti—O appear in the vicinity of 970 cm⁻¹ and 630 cm⁻¹, respectively. Further, in thermal analysis (TG), a mass decrease of about 7% occurred at 390 to 410° C., whereby the pigment is presumed to be a mixed crystal of a 1:1 adduct of titanyl phthalocyanine and (2R,3R)-2,3-butanediol (a dehydration condensation structure shown in the above chemical equation 1) and a non-adduct (non-added) titanyl phthalocyanine.

Using an automatic fluid specific surface area analyzer (Micrometrics Flowsoap type, marketed by Shimadzu Corp.), the BET specific surface area of thus-obtained CG-1 was determined to be 31.2 m²/g.

### Synthesis Example 2

### Synthesis of Titanyl Phthalocyanine of (2S,3S)-2,3-Butanediol Adduct CG-2

There was obtained 10.5 g of pigment CG-2 containing a (2S,3S)-2,3-dutanediol-titanyl phthalocyanine adduct in the same manner as in Synthesis Example 1 except that instead of (2R,3R)-2,3-butanediol, (2S,3S)-2,3-butanediol was used. In the X-ray diffraction spectrum of CG-2, clear peaks appeared at 8.3°, 24.7°, 25.1°, and 26.5°. The BET specific surface area of CG-2 was 30.5 m²/g.

### Synthesis Example 3

There was obtained 10.6 g of pigment CG-3 containing titanyl phthalocyanine of a (2R,3R)-2,3-dutanediol adduct in the same manner as in Synthesis Example 1 except that in the reaction of the amorphous titanyl phthalocyanine and (2R,3R)-2,3-butanediol, the reaction temperature was set at 100 to 110° C. instead of 60 to 70° C. In the X-ray diffraction spectrum of CG-3, clear peaks appeared at 8.3°, 24.7°, 25.1°, and 26.5°. The BET specific surface area of CG-3 was 18.4 m²/g.

### Synthesis Example 4

There was obtained 10.6 g of pigment CG-4 containing titanyl phthalocyanine of a (2R,3R)-2,3-dutanediol adduct in the same manner as in Synthesis Example 1 except that in the reaction of the amorphous titanyl phthalocyanine and (2R,3R)-2,3-butanediol, the reaction temperature was set at 130 to 140° C. instead of 60 to 70° C. In the X-ray diffraction spectrum of CG-4, clear peaks appeared at 8.3°, 24.7°, 25.1°, and 26.5°. The BET specific surface area of CG-4 was 13.5 m²/g.

### Synthesis Example 5

There was obtained 11.0 g of pigment CG-5 containing titanyl phthalocyanine of a (2R,3R)-2,3-dutanediol adduct in the same manner as in Synthesis Example 1 except that in the reaction of the amorphous titanyl phthalocyanine and (2R,3R)-2,3-butanediol, 2.35 g (1.5 equivalent ratio) of (2R,3R)-2,3-dutanediol was used and the reaction temperature was set at 130 to 140° C. In the X-ray diffraction spectrum of CG-5, clear peaks appeared at 9.5°, 16.4°, 19.1°, 24.7°, and 26.5°, as shown in FIG. 2-1. The BET specific surface area of CG-5 was 10.2 m²/g.

### Production of Photoreceptor 1

On a cylindrical aluminum substrate, an intermediate layer coating liquid having a composition described below was immersion-coated to form an intermediate layer of a film thickness of 4.0 μm.

<Intermediate Layer Coating Liquid>

The following composition was dispersed using a wet-system homogenizer of a circulation type.

| | |
|---|---|
| Polyamide resin “CM8000” (produced by Toray Industries, | 10 parts |
| Inc.) | |
| Titanium oxide (number average primary particle diameter: 35 | 30 parts |
| nm, primary surface treatment: silica/alumina treatment, | |
| and secondary surface treatment: methylhydrogen | |
| polysiloxane treatment) | |
| Methanol | 100 parts |

Thereon, the following charge generating layer coating liquid was immersion-coated to form a charge generating layer of a film thickness of 0.3 μm

<Charge Generating Layer Coating Liquid>

The following composition was mixed and dispersed for 1 hour using circulation-type ultrasonic homogenizer RUS-600TCNP (produced by Nissei Corp.).

| | |
|---|---|
| Charge Generating Material: CG-1 of Synthesis Example 1 | 24 parts |
| Polyvinyl butyral resin “S-LEC BL-1” (produced by | 12 parts |
| Sekisui Chemical Co., Ltd.) | |
| 2-Betanone/cyclohexanone = 4/1 (V/V) | 400 parts |

Thereon, a charge transporting layer coating liquid in which the following composition had been mixed was coated, followed by drying by heating at 110° C. for 60 minutes to form a charge transporting layer of a film thickness of 20 μm for production of photoreceptor 1.

<Charge Transporting Layer Coating Liquid>

| | | |
|---|---|---|
| Charge transporting material: compound CT-1 | 200 | parts |
| (triphenylamine-based) | | |
| Polycarbonate “IUPILON Z300” (produced by Mitsubishi | 300 | parts |
| Gas Chemical Company, Inc.) | | |
| 2,6-di-t-Butyl-4-phenylphenol | 5 | parts |
| Toluene/tetrahydrofuran = 1/9 (v/v) | 2000 | parts |

Herein, the above charge generating layer was coated on a transparent PET base and dried so as to achieve a dry film thickness of 0.3 μm to produce a sample for absorption spectrum determination, and then the absorption spectrum thereof was determined using spectrophotometer UV3100 (produced by Shimadzu Corp.). FIG. 1 shows the determined data. The ratio of the absorbance at 780 nm (Abs 780) to the absorbance at 750 nm (Abs 750), namely, Abs 780/Abs 750 was calculated using a value obtained by correcting the absorbance at 1,000 nm as 0. The obtained results are shown in Table 1.

### Production of Photoreceptor 2

Photoreceptor 2 was produced in the same manner as for Photoreceptor 1 except that the dispersion duration of the charge generating material coating liquid was changed to 3 hours.

### Production of Photoreceptor 3

Photoreceptor 3 was produced in the same manner as for Photoreceptor 1 except that as the charge generating material, a change to CG-2, obtained in Synthesis Example 2, was made.

### Production of Photoreceptor 4

Photoreceptor 4 was produced in the same manner as for Photoreceptor 1 except that the dispersion method of the charge generating material was changed to ultrasonic dispersion of the following conditions.

<Charge Generating Layer Coating Liquid>

The following composition was mixed and then dispersed in an ultrasonic washing tank of 28 kHz and 500 W for 2 hours.

| | |
|---|---|
| Charge Generating Material: CG-1 of Synthesis Example 1 | 24 parts |
| Polyvinyl butyral resin “S-LEC BL-1” (produced by | 12 parts |
| Sekisui Chemical Co., Ltd.) | |
| 2-Betanone/cyclohexanone = 4/1 (V/V) | 400 parts |

### Production of Photoreceptor 5

Photoreceptor 5 was produced in the same manner as for photoreceptor 4 except that the dispersion duration of the charge generating material coating liquid was changed to 5 hours.

### Production of Photoreceptor 6

Photoreceptor 6 was produced in the same manner as for Photoreceptor 1 except that the dispersion method of the charge generating material coating liquid was changed to sand mill dispersion of the following conditions.

<Charge Generating Layer Coating Liquid>

The following composition was mixed and then dispersed for 1 hour using a sand mill employing glass beads of an outer diameter of 1 mm as dispersion media having conditions in which the bead filling rate was 80% by volume and the number of rotations was 1000 rpm.

| | |
|---|---|
| Charge Generating Material: CG-1 of Synthesis Example 1 | 24 parts |
| Polyvinyl butyral resin “S-LEC BL-1” (produced by | 12 parts |
| Sekisui Chemical Co., Ltd.) | |
| 2-Betanone/cyclohexanone = 4/1 (V/V) | 400 parts |

### Production of Photoreceptor 7

Photoreceptor 7 was produced in the same manner as for photoreceptor 6 except that as the charge generating material, CG-3, obtained in Synthesis Example 3, was used.

### Production of Comparative Photoreceptor 1

Comparative Photoreceptor 1 was produced in the same manner as for photoreceptor 1 except that the dispersion duration of the charge generating layer coating liquid was changed to 10 hours.

Production of Comparative Photoreceptor 2

Comparative Photoreceptor 2 was produced in the same manner as for photoreceptor 1 except that as the charge generating material, CG-4, obtained in Synthesis Example 4, was used.

Production of Comparative Photoreceptor 3

Comparative Photoreceptor 3 was produced in the same manner as for photoreceptor 6 except that as the charge generating material, CG-5, obtained in Synthesis Example 5, was used.

Production of Comparative Photoreceptor 4

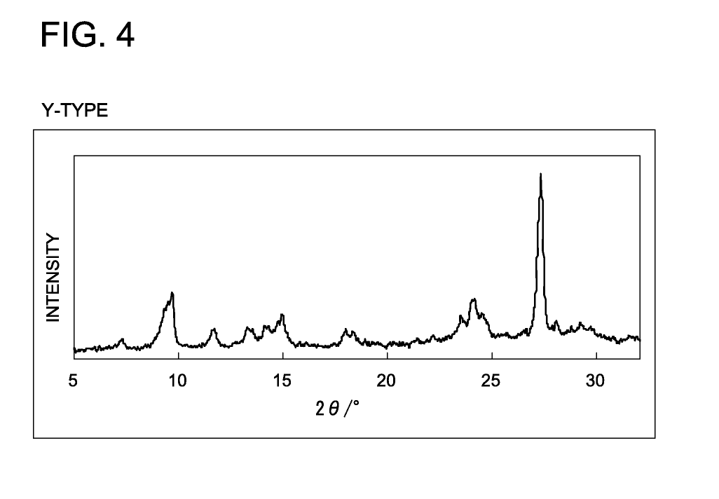

Comparative Photoreceptor 4 was produced in the same manner as for photoreceptor 6 except that CG-1 for the charge generating layer was replaced with Y-type titanyl phthalocyanine. Herein, the Y-type titanyl phthalocyanine is a titanyl phthalocyanine pigment having the maximum peak at 27.2° in the X-ray diffraction spectrum (FIG. 4), being a pigment synthesized based on the following synthesis example.

### Synthesis Example of Y-type Titanyl Phthalocyanine

Titanyl phthalocyanine raw material was synthesized from diiminoisoindoline and tetrabutoxytitanium and dissolved in sulfuric acid, followed by being poured into water. The generated precipitates were filtered and sufficiently washed with water to give aqueous paste of an amorphous titanyl phthalocyanine pigment. The pigment aqueous paste (solid conversion: about 10 g) was dispersed in a mixed liquid of 100 ml of ortho-dichlorobenzene and 100 ml of water (the water layer was separated) and then heated at 70° C. for 6 hours. Thereafter, a crystal generated by being poured into methanol was filtered and dried to give Y-type titanyl phthalocyanine.

With regard to above photoreceptors 2 to 6 and comparative photoreceptors 1 to 4, each absorption spectrum was also determined and the ratio of Abs 780/Abs 750 was calculated in the same manner as the photoreceptor 1. The obtained results are shown in Table 1.

Each of photoreceptors 1 to 7 and comparative photoreceptors 1 to 4 produced as described above was built into digital copier bizhub 920 (produced by Konica Minolta Business Technologies, Inc.) to carry out image output tests.

TABLE 1

| | | BET | | | |
|---|---|---|---|---|---|
| | | Specific | | | |
| | Charge | Surface | CGL | | |
| | Generating | Area | λmax | Abs 780/ | |
| | Material | (m²/g) | (nm) | Abs 750 | |
| Photoreceptor 1 | CG-1 | 31.2 | 758 | 0.76 | inventive |
| Photoreceptor 2 | CG-1 | 31.2 | 755 | 0.72 | inventive |
| Photoreceptor 3 | CG-2 | 30.5 | 760 | 0.81 | inventive |
| Photoreceptor 4 | CG-1 | 31.2 | 769 | 0.92 | inventive |
| Photoreceptor 5 | CG-1 | 31.2 | 760 | 0.82 | inventive |
| Photoreceptor 6 | CG-1 | 31.2 | 751 | 0.63 | inventive |
| Photoreceptor 7 | CG-3 | 18.4 | 753 | 0.67 | inventive |
| Comparative | CG-1 | 31.2 | 746 | 0.42 | non- |
| Photoreceptor 1 | | | | | inventive |
| Comparative | CG-4 | 13.5 | 818 | 1.25 | non- |
| Photoreceptor 2 | | | | | inventive |
| Comparative | CG-5 | 10.2 | 750 | 0.50 | non- |
| Photoreceptor 3 | | | | | inventive |
| Comparative | Y-TiOPc | — | — | — | non- |
| Photoreceptor 4 | | | | | inventive |

Characteristics Evaluation

Characteristics evaluation was carried out based on the following criteria

<Humidity Memory>

Digital copier bizhub 920 descried above was left stand for 24 hours under a high temperature/humidity ambience (HH: 33° C. and 80 RH %), followed by being placed under a low temperature/humidity ambience (LL: 10° C. and 20 RH %), and after an elapsed time of 30 minutes, copying. was carried out. Copying was carried out so that a halftone image of a density of 0.4 in an original image was allowed to have a density of 0.4 and judgment was made based on the density difference (ΔHD=maximum density−minimum density) of a copy image. Image density was determined using RD-918 (produced by Macbeth Co.).

A: ΔHD is at most 0.05 (excellent).

B: ΔHD is more than 0.05 to less than 0.1 (practically non-problematic)

C: ΔHD is at least 0.1 (practically problematic)<

<Initial-Stage and after-Durability Image Evaluation>

Actual printing tests were carried out 200000 times under a high temperature/humidity ambience (HH) for image evaluation.

Evaluation items and judgment criteria each are shown as follows.

Image Density:

A solid black image was produced on a white-background A4 sheet, and using RD-918 (produced by Macbeth Co.), image density was determined. The determination was made based on relative reflection density in which the reflection density of the sheet was designated as “0.” When the residual potential is increased by copying of a large number of sheets, image density was decreased.

A: Solid black image is at least 1.2.

B: Solid black image is 1.0 to less than 1.2.

C: Solid black image is less than 1.0

Image Fog:

Using reflection densitometer RD-918 (produced by Macbeth Co.), the density of a non-printed copy sheet (white sheet) was determined at 20 locations in terms of absolute image density and the average value thereof is designated as the white sheet density. Then, in the same manner, the white-background portion of the copy image was determined at 20 locations in terms of absolute density and then a value obtained by subtracting the above white sheet density from the average density was evaluated as fog density. When the charge potential is decreased to a large extent, fog is generated.

A: Solid white image density is less than 0.005 (excellent).

B: Solid white image density is 0.005 to less than 0.01 (practically non-problematic).

C: Solid white image density is at least 0.01 (practically problematic).

TABLE 2

| | Image Density | | Inage Fog | | | |
|---|---|---|---|---|---|---|
| | Initial- | After- | Initial- | After- | Humidity | |
| | stage | durability | stage | durability | Memory | |
| Photoreceptor 1 | A | A | A | A | A | inventive |
| Photoreceptor 2 | A | B | A | B | A | inventive |
| Photoreceptor 3 | A | A | A | A | A | inventive |
| Photoreceptor 4 | A | A | A | B | A | inventive |
| Photoreceptor 5 | A | A | A | A | A | inventive |
| Photoreceptor 6 | A | B | A | B | A | inventive |
| Photoreceptor 7 | A | B | B | B | B | inventive |
| Comparative | B | C | B | C | A | non-inventive |
| Photoreceptor 1 | | | | | | |
| Comparative | B | C | C | C | B | non-inventive |
| Photoreceptor 2 | | | | | | |
| Comparative | C | C | C | C | B | non-inventive |
| Photoreceptor 3 | | | | | | |
| Comparative | A | A | A | A | C | non-inventive |
| Photoreceptor 4 | | | | | | |

The results confirm that any characteristics of photoreceptors 1 to 7 are at least practically non-problematic but at least one of the characteristics of comparative photoreceptors 1 to 4 is problematic.

1. An electrophotographic photoreceptor having a photosensitive layer on a conductive support, wherein
the photosensitive layer comprises a pigment containing an adduct of titanyl phthalocyanine and at least either of (2R,3R)-2,3-butanediol and (2S,3S)-2,3-butanediol,
a spectrum of the photosensitive layer has an absorption maximum value in a region of 750 to 780 nm, and
a ratio of Abs 780/Abs 750, a value obtained by correcting the absorbance at 1000 nm as 0, is 0.6 to 1.0, wherein Abs 780 is an absorbance at 780 nm and Abs 750 is an absorbance at 750 nm of the photosensitive layer.

2. The electrophotographic photoreceptor of claim 1, wherein the pigment has a peak at least at a Bragg angle (2θ±0.2°) of 8.3° in the X-ray diffraction spectrum.

3. The electrophotographic photoreceptor of claim 1, wherein a BET specific surface area of the pigment is at least 20 m²/g.

4. The electrophotographic photoreceptor of claim 3, wherein a BET specific surface area of the pigment is at least 30 m²/g.

5. The electrophotographic photoreceptor of claim 1, wherein the ratio of Abs 780/Abs 750 is 0.65 to 0.95.

6. The electrophotographic photoreceptor of claim 5, wherein the ratio of Abs 780/Abs 750 is 0.7 to 0.9.

7. The electrophotographic photoreceptor of claim 1, wherein a ratio of the butanediol adduct to titanyl phthalocyanine is presumed to be 40 to 70 mol %.

8. An image forming apparatus provided with at least a member to form an electrostatic latent image on an electrophotographic photoreceptor of claim 1, a member to develop the electrostatic latent image using a toner, a member to transfer a formed toner image on an image support, and a member to fix a transferred toner image.
